(19) United States
(12) Patent Application Publication
(10) Pub. No.: US 2015/0276914 A1
(43) Pub. Date: Oct. 1, 2015

(54) ELECTRONIC DEVICE AND CONTROL METHOD FOR ELECTRONIC DEVICE

(71) Applicant: Kabushiki Kaisha Toshiba, Tokyo (JP)

(72) Inventor: Fumitoshi Mizutani, Hamura Tokyo (JP)

(21) Appl. No.: 14/668,869

(22) Filed: Mar. 25, 2015

(30) Foreign Application Priority Data
Mar. 31, 2014 (JP) 2014-071634

(51) Int. Cl. G01S 3/805

(52) U.S. Cl. CPC G01S 3/805

(57) ABSTRACT

According to one embodiment, an electronic device includes an acceleration sensor and a processor. The acceleration sensor detects acceleration. The processor estimates a direction of a speaker utilizing a phase difference of voices input to microphones, and initializes data associated with estimation of the direction of the speaker, based on the acceleration detected by the acceleration sensor.

### CROSS-REFERENCE TO RELATED APPLICATIONS

This application is based upon and claims the benefit of priority from Japanese Patent Application No. 2014-071634, filed Mar. 31, 2014, the entire contents of which are incorporated herein by reference.

### FIELD

Embodiments described herein relate generally to a technique of estimating the direction of a speaker.

### BACKGROUND

Electronic devices configured to estimate the direction of a speaker based on phase differences between corresponding frequency components of a voice input to a plurality of microphones have recently been developed.

When voices are collected by an electronic device held by a user, the accuracy of estimating the direction of a speaker (another person) may be reduced.

It is an object of the invention to provide an electronic device capable of suppressing reduction of the accuracy of estimating the direction of a speaker, even though voices are collected by the electronic device held by a user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic device according to an embodiment.

FIG. 2 is an exemplary block diagram showing the configuration of the electronic device of the embodiment.

FIG. 3 is an exemplary functional block diagram of a recording application.

FIG. 4A and FIG. 4B are views for explaining the direction of a sound source, and an arrival time difference detected in a sound signal.

FIG. 5 is a view showing the relationship between frames and a frame shift amount.

FIG. 6A, FIG. 6B, and FIG. 6C are views for explaining the procedure of FFT processing and short-term Fourier transform data.

FIG. 7 is an exemplary functional block diagram of an utterance direction estimation module.

FIG. 8 is an exemplary functional block diagram showing the internal configurations of a two-dimensional data generation module and a figure detector.

FIG. 9 is a view showing the procedure of calculating a phase difference.

FIG. 10 is a view showing the procedure of calculating coordinates.

FIG. 11 is an exemplary functional block diagram showing the internal configuration of a sound source information generation module.

FIG. 12 is a view for explaining direction estimation.

FIG. 13 is a view showing the relationship between θ and ΔT.

FIG. 14 shows an exemplary an image displayed by a user interface display processing module.

FIG. 15 is an exemplary flowchart showing a procedure of initializing data associated with speaker identification.

### DETAILED DESCRIPTION

Various embodiments will be described hereinafter with reference to the accompanying drawings.

In general, according to one embodiment, an electronic device includes an acceleration sensor and a processor. The acceleration sensor detects acceleration. The processor estimates a direction of a speaker utilizing a phase difference of voices input to microphones, and initializes data associated with estimation of the direction of the speaker, based on the acceleration detected by the acceleration sensor.

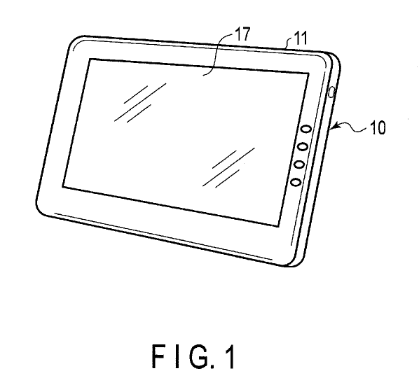

Referring first to FIG. 1, the structure of an electronic device according to the embodiment will be described. This electronic device can be realized as a portable terminal, such as a tablet personal computer, a laptop or notebook personal computer or PDA. Hereinafter, it is assumed that the electronic device is realized as a tablet personal computer 10 (hereinafter, the computer 10).

FIG. 1 is a perspective view showing the outer appearance of the computer 10. As shown, the computer 10 comprises a computer main unit 11 and a touch screen display 17. The computer main unit 11 has a thin box-shaped casing. The touch screen display 17 is placed on the computer main unit 11. The touch screen display 17 comprises a flat panel display (e.g., a liquid crystal display (LCD)) and a touch panel. The touch panel covers the LCD. The touch panel is configured to detect the touch position of a user finger or a stylus on the touch screen display 17.

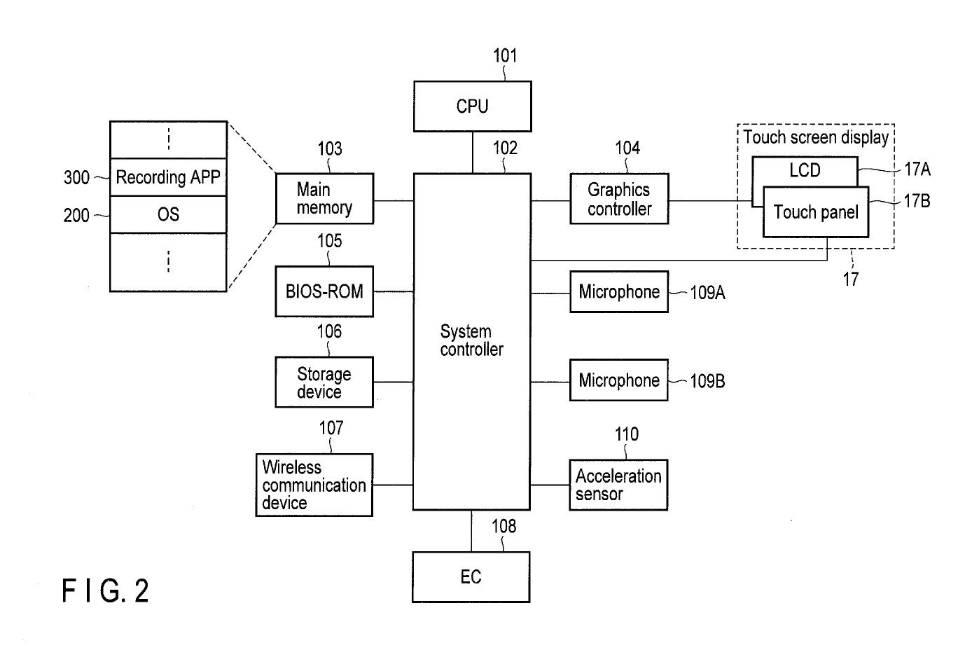

FIG. 2 is a block diagram showing the configuration of the computer 10.

As shown in FIG. 2, the computer 10 comprises the touch screen display 17, a CPU 101, a system controller 102, a main memory 103, a graphics controller 104, a BIOS-ROM 105, a nonvolatile memory 106, an embedded controller (EC) 108, microphones 109A and 109B, an acceleration sensor 110, etc.

The CPU 101 is a processor configured to control the operations of various modules in the computer 10. The CPU 101 executes various types of software loaded from the nonvolatile memory 106 onto the main memory 103 as a volatile memory. The software includes an operating system (OS) 200 and various application programs. The application programs include a recording application 300.

The CPU 101 also executes a basic input output system (BIOS) stored in the BIOS-ROM 105. The BIOS is a program for hardware control.

The system controller 102 is configured to connect the local bus of the CPU 101 to various components. The system controller 102 contains a memory controller configured to perform access control of the main memory 103. The system control 102 also has a function of communicating with the graphics controller 104 via, for example, a serial bus of the PCI EXPRESS standard.

The graphics controller 104 is a display controller configured to control an LCD 17A used as the display monitor of the computer 10. Display signals generated by the graphics controller 104 are sent to the LCD 17A. The LCD 17A displays screen images based on the display signals. On the LCD 17A, a touch panel 17B is provided. The touch panel 17B is a pointing device of an electrostatic capacitance type configured to perform inputting on the screen of the LCD 17A. The contact position of a finger on the screen, the movement of the contact position on the screen, and the like, are detected by the touch panel 17B.

An EC 108 is a one-chip microcomputer including an embedded controller for power management. The EC 108 has a function of turning on and off the computer 10 in accordance with a user's operation of a power button.

An acceleration sensor 110 is configured to detect the X-, Y- and Z-axial acceleration of the computer 10. The movement direction of the computer 10 can be detected by detecting the X-, Y- and Z-axial acceleration.

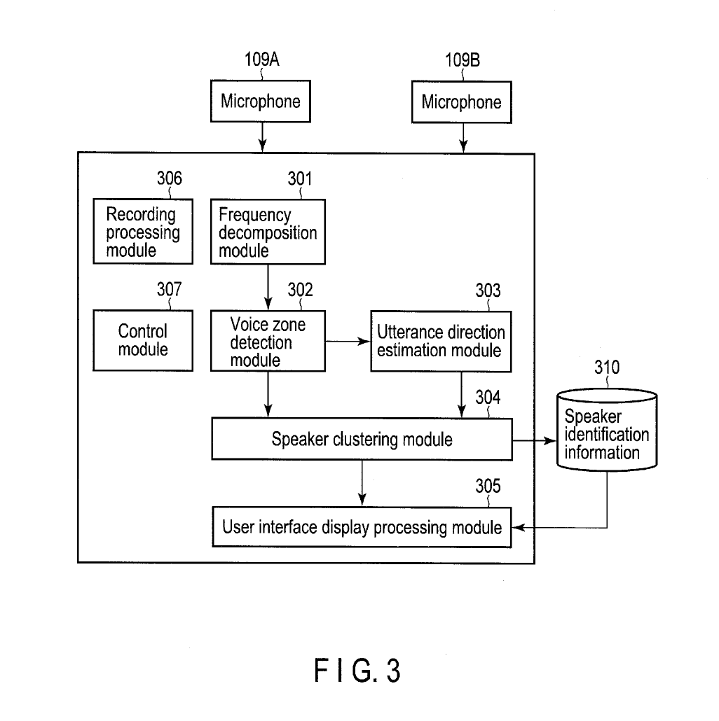

FIG. 3 is a functional block diagram of the recording application 300.

As shown, the recording application 300 comprises a frequency decomposing module 301, a voice zone detection module 302, an utterance direction estimation module 303, a speaker clustering module 304, a user interface display processing module 305, a recording processing module 306, a control module 307, etc.

The recording processing module 306 performs recording processing of, for example, performing compression processing on voice data input through the microphones 109A and 109B and storing the resultant data in the storage device 106.

The control module 307 can control the operations of the modules in the recording application 300.

[Basic Concept of Sound Source Estimation Based on Phase Differences Corresponding to Respective Frequency Components]

The microphones 109A and 109B are located in a medium, such as air, with a predetermined distance therebetween, and are configured to convert medium vibrations (sound waves) at different two points into electric signals (sound signals). Hereinafter, when the microphones 109A and 109B are treated collectively, they will be referred to as a microphone pair.

A sound signal input module 2 is configured to regularly perform A/D conversion of the two sound signals of the microphones 109A and 109B at a predetermined sampling period Fr, thereby generating amplitude data in a time-sequence manner.

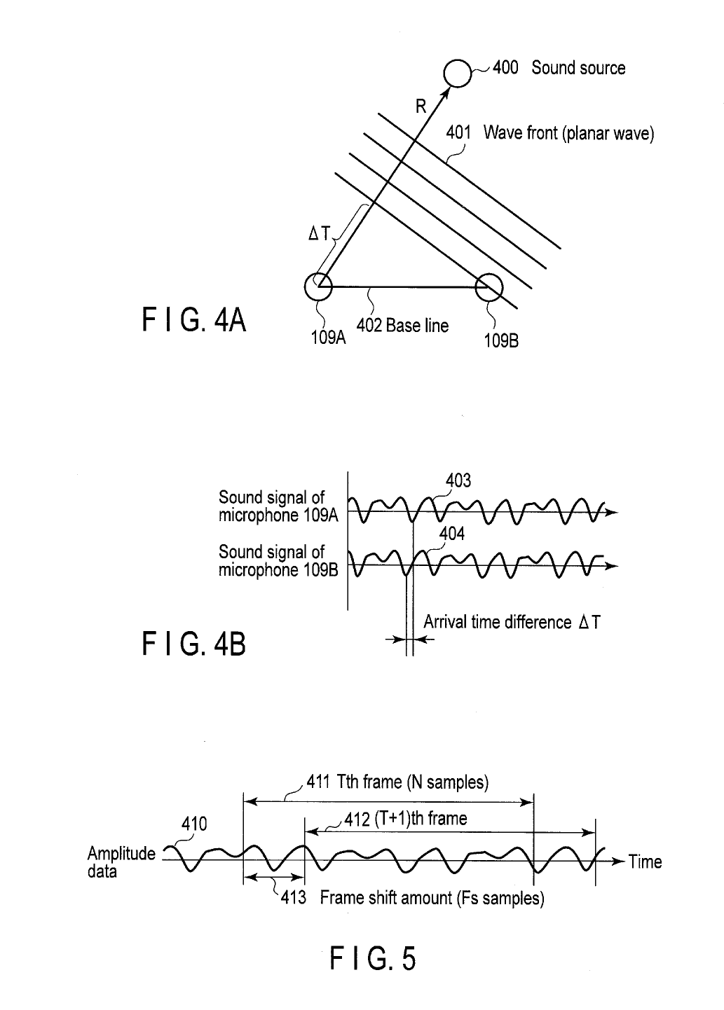

Assuming that a sound source is positioned in a sufficiently far place compared to the distance between the microphones, the wave front 401 of a sound wave generated from a sound source 400 to the microphone pair is substantially flat, as is shown in FIG. 4(A). When observing the planar wave at two different points using the microphones 109A and 109B, a predetermined arrival time difference ΔT must be detected between sound signals from the microphone pair in association with the direction R of the sound source 400 with respect to a line segment 402 (called a base line) connecting the microphone pair. When the sound source exists in a sufficiently far place, the arrival time difference ΔT is 0 if the sound source 400 exists in a plane perpendicular to the base line 403. This direction is defined as a front direction with respect to the microphone pair.

[Frequency Decomposing Module]

Fast Fourier transform (FFT) is a general method of decomposing amplitude data into frequency components. As a typical algorithm, Cooley-Turkey DFT algorithm is known, for example.

As shown in FIG. 5, the frequency decomposing module 301 extracts subsequent N amplitude data items as a frame (T^{th} frame 411) from amplitude data 410 generated by the sound signal input module 2, and subjects the frame to FFT. The frequency decomposing module 301 repeats this processing with the extraction position shifted by a certain frame shift amount 413 in each loop ((T+1)^{th} frame 412).

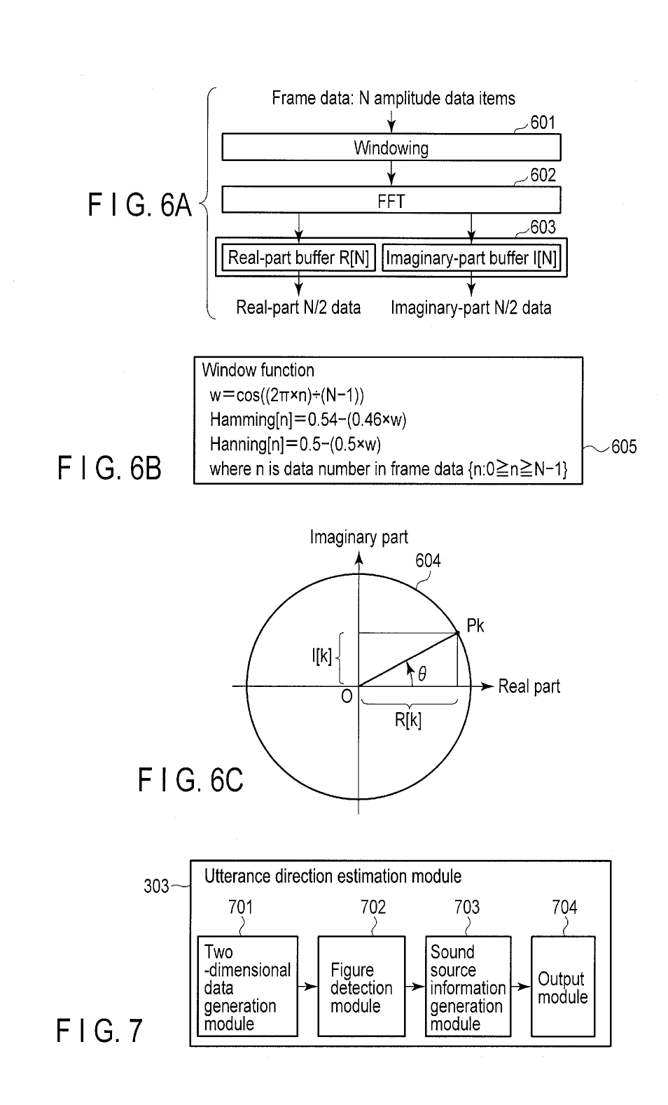

The amplitude data constituting a frame is subjected to windowing 601 and then to FFT 602, as is shown in FIG. 6(A). As a result, short-term Fourier transform data corresponding to the input frame is generated in a real-part buffer R[N] and an imaginary-part buffer I[N]. FIG. 6(B) shows an example of a window function (Hamming or Hanning window function) 605.

The generated short-term Fourier transform data is the data obtained by decomposing the amplitude data of the frame into N/2 frequency components, and the values in the real-part R[k] and the imaginary-part I[k] of a buffer 603 associated with the k^{th} frequency component fk indicate a point Pk on a complex coordinate system 604. The square of the distance between the point Pk and the origin O corresponds to the power Po(fk) of the frequency component fk, and the signed rotation angle θ{θ: −π>θ≧π [radian]} from the real-part axis Pk is the phase Ph(fk) of the frequency component fk.

When Fr [Hz] represents the sampling frequency, N [samples] represents the frame length, k assumes an integer value ranging from 0 to (N/2)−1, k=0 represents 0 [Hz] (DC current), k=(N/2)−1 represents Fr/2 [Hz] (the highest frequency component), the values obtained by equally dividing the frequency range from k=0 to k=(N/2)−1 by a frequency resolution Δf=(Fr/2)/((N/2)−1) [Hz] represents a frequency at each k, and fk is given by k×Δf.

As aforementioned, the frequency decomposing module 301 sequentially performs the above processing at regular intervals (frame shift amount Fs), thereby generating, in a time-sequence manner, a frequency decomposition data set including power values and phases corresponding to the respective frequencies of the input amplitude data.

[Voice Zone Detection Module]

The voice zone detection module 302 detects voice zones based on the decomposition result of the frequency decomposing module 301.

[Utterance Direction Estimation Module]

The utterance direction estimation module 303 detects the utterance directions in the respective voice zones based on the detection result of the voice zone detection module 302.

FIG. 7 is a functional block diagram of the utterance direction estimation module 303.

The utterance direction estimation module 303 comprises a two-dimensional data generation module 701, a figure detection module 702, a sound source information generation module 703, and an output module 704.

(Two-Dimensional Data Generation Module and Figure Detection Module)

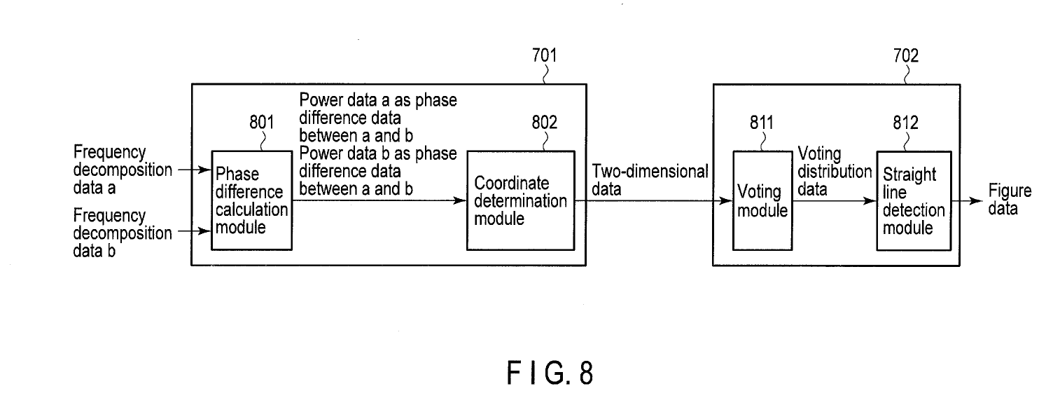

As shown in FIG. 8, the two-dimensional data generation module 701 comprises a phase difference calculation module 801 and a coordinate determination module 802. The figure detection module 702 comprises a voting module 811 and a straight line detection module 812.

[Phase Difference Calculation Module]

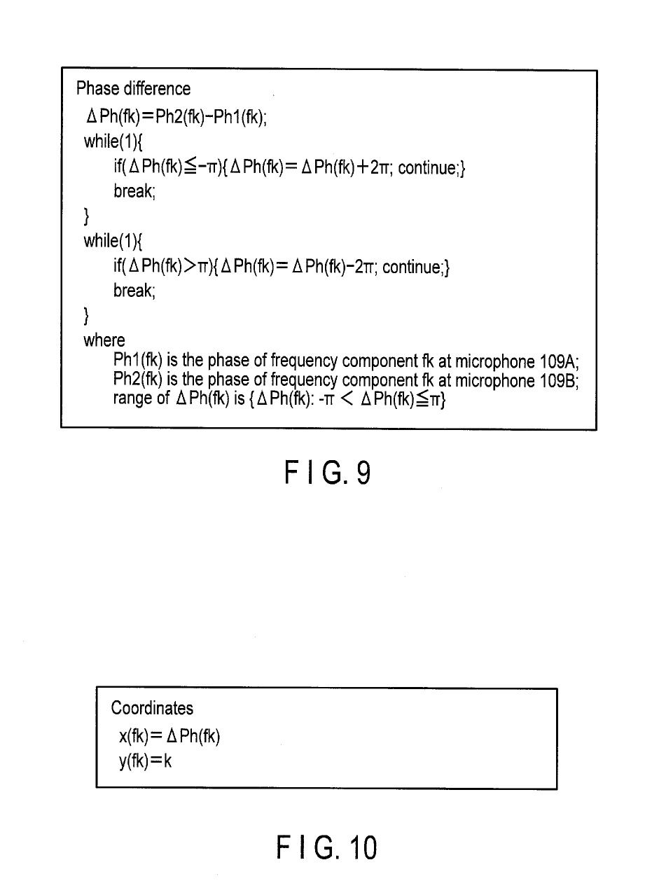

The phase difference calculation module 801 compares two frequency decomposition data sets a and b simultaneously obtained by the frequency decomposing module 301, thereby generating phase difference data between a and b as a result of calculation of phase differences therebetween corresponding to the respective frequency components. For instance, as shown in FIG. 9, the phase difference ΔPh(fk) corresponding to a certain frequency component fk is calculated as a residue system of 2π so that the difference between a phase Ph1(fk) at the microphone 109A and a phase Ph2(fk) at the microphone 109B is calculated, and is controlled to fall within {ΔPh(fk): −π<ΔPh(fk)≦π}.

[Coordinate Determination Module]

The coordinate determination module 802 is configured to determine coordinates for treating the phase difference data calculated by the phase difference calculation module 801 as points on a predetermined two-dimensional XY coordinate system. The X coordinate x(fk) and the Y coordinate y(fk) corresponding to a phase difference ΔPh(fk) associated with a certain frequency component fk are determined by the equations shown in FIG. 10. Namely, the X coordinate is the phase difference ΔPh(fk), and the Y coordinate is the frequency component number k.

[Voting Module]

The voting module 811 is configured to apply linear Hough transform to each frequency component provided with (x, y) coordinates by the coordinate determination module 802, and to vote the locus of the resultant data in a Hough voting space by a predetermined method.

[Straight Line Detection Module]

The straight line detection module 812 is configured to analyze a voting distribution in the Hough voting space generated by the voting module 811 to detect a dominant straight line.

[Sound Information Generation Module]

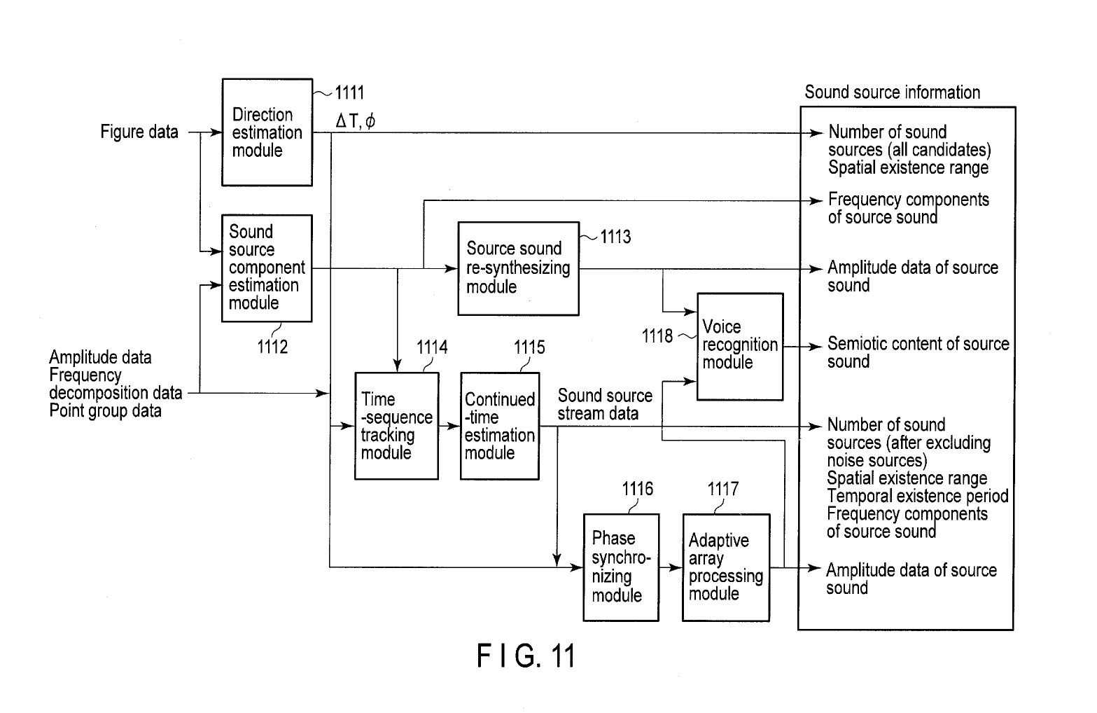

As shown in FIG. 11, the sound source information generation module 703 comprises a direction estimation module 1111, a sound source component estimation module 1112, a source sound re-synthesizing module 1113, a time-sequence tracking module 1114, a continued-time estimation module 1115, a phase synchronizing module 1116, an adaptive array processing module 1117 and a voice recognition module 1118.

[Direction Estimation Module]

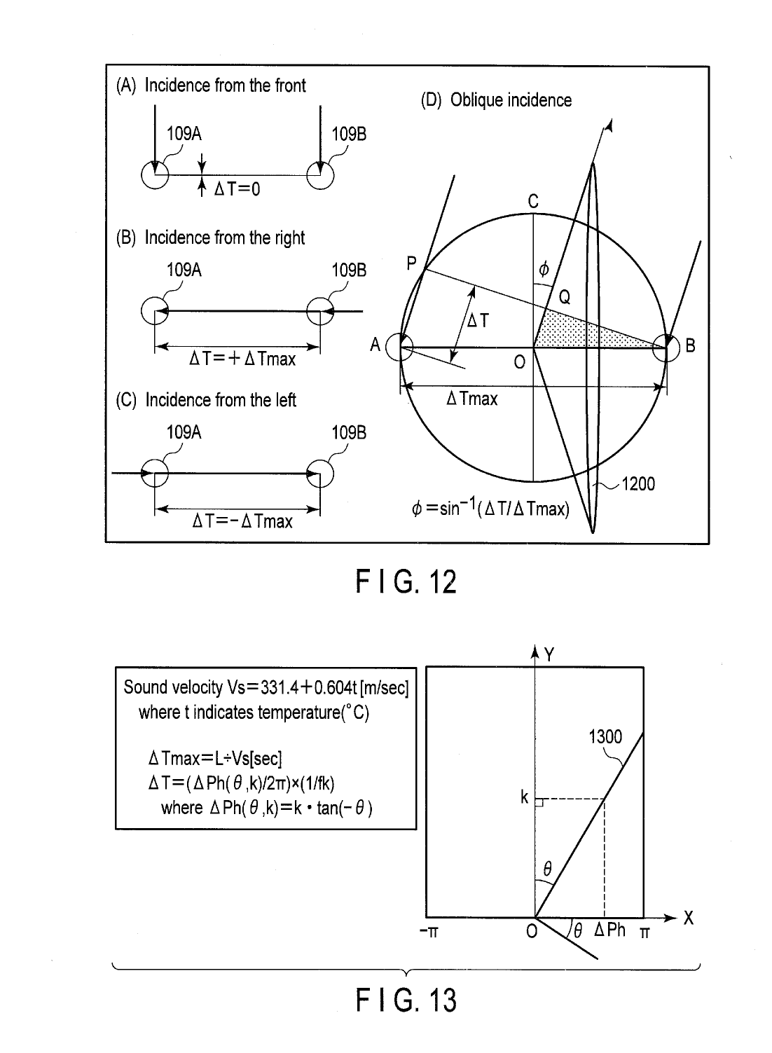

The direction estimation module 1111 receives the result of straight line detection by the straight line detection module 812, i.e., receives θ values corresponding to respective straight line groups, and calculates sound source existing ranges corresponding to the respective straight line groups. At this time, the number of the detected straight line groups is the number of sound sources (all candidates). If the distance between the base line of the microphone pair and the sound source is sufficiently long, the sound source existing range is a circular conical surface of a certain angle with respect to the base line of the microphone pair. This will be described with reference to FIG. 12.

The arrival time difference ΔT between the microphones 109A and 109B may vary within a range of ±ΔTmax. As shown in FIG. 12(A), when a sound enters the microphones from the front, ΔT is 0, and the azimuth angle φ of the sound source is 0° with respect to the front side. Further, as shown in FIG. 12(B), when a sound enters the microphones just from the right, i.e., from the microphone 109B side, ΔT is equal to +ΔTmax, and the azimuth angle φ of the sound source is +90° with respect to the front side, assuming that the clockwise direction is regarded as the + direction. Similarly, as shown in FIG. 12(C), when a sound enters the microphones just from the left, i.e., from the microphone 109A side, ΔT is equal to −ΔTmax, and the azimuth angle φ is −90°. Thus, ΔT is defined such that it assumes a positive value when a sound enters the microphones from the right, and assumes a negative value when a sound enters them from the left.

In view of the above, such general conditions as shown in FIG. 12(D) will be determined. Assuming that the positions of the microphones 109A and 109B are A and B, respectively, and a sound enters the microphones in a direction parallel to a line segment PA, ΔPAB is a right-angled triangle with an apex P set as a right angle. At this time, the azimuth angle φ is defined as a counterclockwise angle from an OC line segment set as an azimuth angle of 0°, assuming that O is the center of the microphone pair, and the line segment OC indicates the front direction of the microphone pair. Since ΔQOB is similar to ΔPAB, the absolute value of the azimuth angle φ is equal to ∠OBQ, i.e., ∠ABP, and the sign of the azimuth angle φ is identical to that of ΔT. Further, ∠ABP can be calculated at sin⁻¹ of the ratio between PA and AB. At this time, if the line segment PA is expressed as corresponding ΔT, the line segment AB corresponds to ΔTmax. Accordingly, the azimuth angle φ is calculated at sin⁻¹ (ΔT/ΔTmax) including its sign. The existing range of the sound source is estimated as a conic surface 1200 opening from the point O as an apex through (90−φ)° about the base line AB as an axis. The sound source exists somewhere on the conic surface 1200.

As shown in FIG. 13, ΔTmax is obtained by dividing the distance L [m] between the microphone pair by the sonic velocity Vs [m/sec]. The sonic velocity Vs is known to be approximated using the temperature t [° C.] as a function. Assume here that a straight line 1300 is detected as a Hough's gradient θ by the straight line detection module 812. Since the straight line 1300 inclines rightward, θ assumes a negative value. When y=k (frequency fk), the phase difference ΔPh indicated by the straight line 1300 can be calculated at k·tan(−θ) as a function of k and θ. At this time, ΔT [sec] is the time obtained by multiplying one period (1/fk) [sec] of the frequency fk by the ratio of the phase difference ΔPh (θ, k) to 2π. Since θ is a value with a sign, ΔT is also a value with a sign. Namely, in FIG. 12(D), if a sound enters the microphone pair from the right (if the phase difference ΔPh is a positive value), θ is a negative value. Further, in FIG. 12(D), if a sound enters the microphone pair from the left (if the phase difference ΔPh is a negative value), θ is a positive value. Therefore, the sign of θ is inverted. In actual calculations, it is sufficient if calculation is performed assuming that k=1 (a frequency just above the DC component k=0).

[Sound Source Component Estimation Module]

The sound source component estimation module 1112 estimates the coordinates (x, y) corresponding to respective frequencies and supplied from the coordinate determination module 802, and the distance to the straight line supplied from the straight line detection module 802, thereby detecting a point (i.e., a frequency component) near the straight line as the frequency component of the straight line (i.e., the sound source), and estimating the frequency component corresponding to each sound source based on the detection result.

[Source Sound Synthesis Module]

The source sound re-synthesizing module 1113 performs FFT of frequency components constituting source sounds and obtained at the same time point, thereby re-synthesizing the source sounds (amplitude data) in a frame zone starting from the time point. As shown in FIG. 5, one frame overlaps with a subsequent frame, with a time difference corresponding to a frame shift amount. In a zone where a plurality of frames overlap, the amplitude data items of all overlapping frames can be averaged into final amplitude data. By this processing, the source sound can be separated and extracted as its amplitude data.

[Time-Sequence Tracking Module]

The straight line detection module 812 obtains a straight line group whenever the voting module 811 performs a Hough voting. The Hough voting is collectively performed on subsequent m (m≧1) FFT results. As a result, the straight line groups are obtained in a time-sequence manner, using a time corresponding to a frame as a period (this will hereinafter be referred to as “the figure detection period”). Further, since θ values corresponding to the straight line groups are made to correspond to the respective sound source directions φ calculated by the direction estimation module 1111, the locus of θ (or φ) in the time domain corresponding to a stable sound source must be continuous regardless of whether the sound source is stationary or moving. In contrast, the straight line groups detected by the straight line detection module 812 may include a straight line group corresponding to background noise (this will hereinafter be referred to “the noise straight line group”) depending upon the setting of the threshold. However, the locus of θ (or φ) in the time domain associated with such a noise straight line group is expected not to be continuous, or expected to be short even though it is continuous.

The time-sequence tracking module 1114 is configured to detect the locus of φ in the time domain by classifying φ values corresponding to the figure detection periods into temporally continuous groups.

[Continued-Time Estimation Module]

The continued-time estimation module 1115 receives, from the time-sequence tracking module 1114, the start and end time points of locus data whose tracking is finished, and calculates the continued time of the locus, thereby determining that the continued time is locus data based on the source sound, if it exceeds a predetermined threshold. The locus data based on the source sound will be referred to as sound source stream data. The sound source stream data includes data associated with the start time point Ts and the end time point Te of the source sound, and time-sequence locus data θ, φ and ρ indicating directions of the source sound. Further, although the number of the straight line groups detected by the figure detection module 702 is associated with the number of sound sources, the straight line groups also include noise sources. The number of the sound source stream data items detected by the sound source continued-time estimation module 1115 provides the reliable number of sound sources excluding noise sources.

[Phase Synchronizing Module]

The phase synchronizing module 1116 refers to the sound source stream data output from the time-sequence tracking module 1114, thereby detecting temporal changes in the sound source direction φ indicated by the stream data, and calculating an intermediate value φmid (=(φmax+φmin)/2) from the maximum value φ max and minimum value φmin of φ and a width φw (=(φmax−φmin)). Further, time-sequence data items corresponding to two frequency decomposition data sets a and b as the members of the sound source stream data are extracted for the time period ranging from the time point earlier by a predetermined time period than the start time point Ts, to the time point later by a predetermined time period than the end time point Te. These extracted time-sequence data items are corrected to cancel the arrival time difference calculated by back calculation based on the intermediate value φmid. As a result, phase synchronization is achieved.

Alternatively, the time-sequence data items corresponding to the two frequency decomposition data sets a and b can be always synchronized in phase by using, as φmid, the sound source direction φ at each time point detected by the direction estimation module 1111. Whether the sound source stream data or φ at each time point is referred to is determined based on an operation mode. The operation mode can be set as a parameter and can be changed.

[Adaptive Array Processing Module]

The adaptive array processing module 1117 causes the central directivity of the extracted and synchronized time-sequence data items corresponding to the two frequency decomposition data sets a and b to be aligned with the front direction 0°, and subjects the time-sequence data items to adaptive array processing in which the value obtained by adding a predetermined margin to ±φw is used as a tracking range, thereby separating and extracting, with high accuracy, time-sequence data corresponding to the frequency components of the stream source sound data. This processing is similar to that of the sound source component estimation module 1112 in separating and extracting the time-sequence data corresponding to the frequency components, although the former differs from the latter in method. Thus, the source sound re-synthesizing module 1113 can re-synthesize the amplitude data of the source sound also from the time-sequence data of the frequency components of the source sound, obtained by the adaptive array processing module 1117.

As the adaptive array processing, a method of clearly separating and extracting a voice within a set directivity range can be applied. For instance, see reference document 3, Tadashi Amada et al., “A Microphone Array Technique for Voice Recognition,” Toshiba Review 2004, Vol. 59, No. 9, 2004, which describes the use of two (main and sub) “Griffith-Jim type generalized side-lobe cancellers,” known as means for realizing a beam-former constructing method.

In general, when using adaptive array processing, a tracking range is beforehand set, and only voices within the tracking range are detected. Therefore, in order to receive voices in all directions, it is necessary to prepare a large number of adaptive arrays having different tracking ranges. In contrast, in the embodiment, the number of sound sources and their directions are firstly determined, and then only adaptive arrays corresponding to the number of sound sources are operated. Moreover, the tracking range can be limited to a predetermined narrow range corresponding to the directions of the sound sources. As a result, the voices can be separated and extracted efficiently and excellently in quality.

Further, in the embodiment, the time-sequence data associated with the two frequency decomposition data sets a and b are beforehand synchronized in phase, and hence voices in all directions can be processed by setting the tracking range only near the front direction in adaptive array processing.

[Voice Recognition Module]

The voice recognition module 1118 analyzes the time-sequence data of the frequency components of the source sound extracted by the sound source component estimation module 1112 or the adaptive array processing module 1117, to thereby extract the semiotic content of the stream data, i.e., its linguistic meaning or a signal (sequence) indicative of the type of the sound source or the speaker.

It is supposed that the functional blocks from the direction estimation module 1111 to the voice recognition module 1118 can exchange data with each other via interconnects not shown in FIG. 11, when necessary.

The output module 704 is configured to output, as the sound source information generated by the sound source information generation module 703, information that includes at least the number of sound sources obtained as the number of straight line groups by the figure detection module 702, the spatial existence range (the angle φ for determining a conical surface) of each sound source as a source of sound signals, estimated by the direction estimation module 1111, the component structure (the power of each frequency component and time-sequence data associated with phases) of a voice generated by each sound source, estimated by the sound source estimation module 1112, separated voices (the time-sequence data associated with amplitude values) corresponding to the respective sound sources and synthesized by the source sound re-synthesizing module 1113, the number of sound sources excluding noise sources and determined based on the time-sequence tracking module 1114 and the continued-time estimation module 1115, the temporal existence range of a voice generated by each sound source, determined by the time-sequence tracking module 1114 and the continued-time estimation module 1115, separated voices (time-sequence data of amplitude values) of the respective sound sources determined by the phase synchronizing module 1116 and the adaptive array processing module 1117, or the semiotic content of each source sound obtained by the voice recognition module 1118.

[Speaker Clustering Module]

The speaker clustering module 304 generates speaker identification information 310 per each time point based on, for example, the temporal existence period of a voice generated by each sound source, output from the output module 704. The speaker identification information 310 includes an utterance start time point, and information associated by a speaker with the utterance start time point.

[User Interface Display Processing Module]

The user interface display processing module 305 is configured to present, to a user, various types of content necessary for the above-mentioned sound signal processing, to accept a setting input by the user, and to write set content to an external storage unit and read data therefrom. The user interface display processing module 305 is also configured to visualize various processing results or intermediate results, to present them to the user, and to enable them to select desired data, more specifically, configured (1) to display frequency components corresponding to the respective microphones, (2) to display a phase difference (or time difference) plot view (i.e., display of two-dimensional data), (3) to display various voting distributions, (4) to display local maximum positions, (5) to display straight line groups on a plot view, (6) to display frequency components belonging to respective straight line groups, and (7) to display locus data. By virtue of the above structure, the user can confirm the operation of the sound signal processing device according to the embodiment, can adjust the device so that a desired operation will be performed, and thereafter can use the device in the adjusted state.

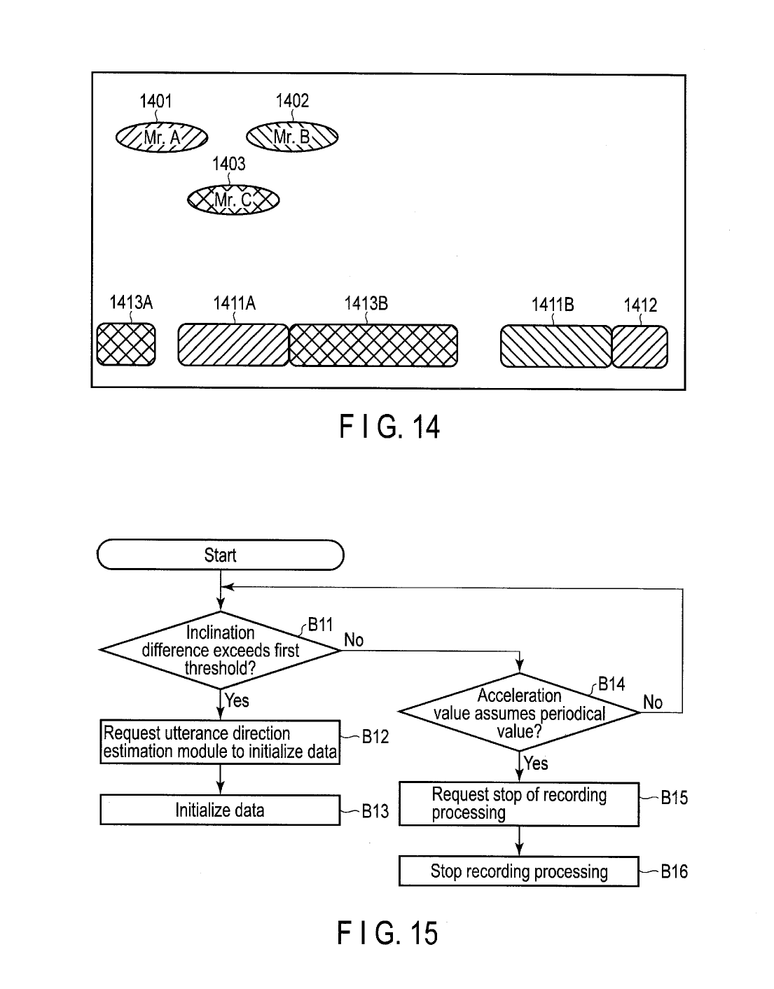

The user interface display processing module 305 displays, for example, such a screen image as shown in FIG. 14 on the LCD 17A based on the speaker identification information 310.

In FIG. 14, objects 1401, 1402 and 1403 indicating speakers are displayed on the upper portion of the LCD 17A. Further, on the lower portion of the LCD 17A, objects 1411A, 1411B, 1412, 1413A and 1413B indicative of utterance time periods are displayed. Upon occurrence of an utterance, the objects 1413A, 1411A, 1413B, 1411B and 1412 are moved in this order from the right to the left with lapse of time. The objects 1411A, 1411B, 1412, 1413A and 1413B are displayed in colors corresponding to the objects 1401, 1402 and 1403.

In general, speaker identification utilizing a phase difference due to the distance between microphones will be degraded in accuracy if the device is moved during recording. The device of the embodiment can suppress degradation of convenience due to accuracy reduction by utilizing, for speaker identification, the X-, Y- and Z-axial acceleration obtained by the acceleration sensor 110 and the inclination of the device.

The control module 307 requests the utterance direction estimation module 303 to initialize data associated with processing of estimating the direction of the speaker, based on the acceleration detected by the acceleration sensor.

FIG. 15 is a flowchart showing a procedure of initializing data associated with speaker identification.

The control module 307 determines whether the difference between the inclination of the device 10 detected by the acceleration sensor 110, and that of the device 10 assumed when speaker identification has started exceeds a threshold (block B11). If it exceeds the threshold (Yes in block B11), the control module 307 requests the utterance direction estimation module 303 to initialize data associated with speaker identification (block B12). The utterance direction estimation module 303 initializes the data associated with the speaker identification (block B13). After that, the utterance direction estimation module 303 performs speaker identification processing based on data newly generated by each element in the utterance direction estimation module 303.

If determining that the initial state is not exceeded (No in block B11), the control module 307 determines whether the X-, Y- and Z-axial acceleration of the device 10 obtained by the acceleration sensor 110 assumes periodic values (block B14). If determining that the acceleration assumes periodic values (Yes in block B14), the control module 307 requests the recording processing module 306 to stop recording processing (block B15). Further, the control module 307 requests the frequency decomposing module 301, the voice zone detection module 302, the utterance direction estimation module 303 and the speaker clustering module 304 to stop their operations. The recording processing module 306 stops recording processing (block B16). The frequency decomposing module 301, the voice zone detection module 302, the utterance direction estimation module 303 and the speaker clustering module 304 stop their operations.

In the embodiment, the utterance direction estimation module 303 is requested to initialize data associated with processing of estimating the direction of a speaker, based on the acceleration detected by the acceleration sensor 110. As a result, degradation of accuracy of estimating the direction of the speaker can be suppressed, even though voices are collected with the electronic device held by the user.

The processing performed in the embodiment can be realized by a computer program. Therefore, the same advantage as that of the embodiment can be easily obtained by installing the computer program in a computer through a computer-readable recording medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an acceleration sensor to detect acceleration; and
a processor to estimate a direction of a speaker utilizing a phase difference of voices input to microphones, and to initialize data associated with estimation of the direction of the speaker, based on the acceleration detected by the acceleration sensor.

2. The device of claim 1, wherein the processor initializes the data when a difference between a direction of the device determined from the acceleration detected by the acceleration sensor and an initial direction of the device exceeds a threshold.

3. The device of claim 1, wherein the processor records a particular voice input to the microphones, and stops recording when the acceleration detected by the acceleration sensor is periodic.

4. A method of controlling an electronic device comprising an acceleration sensor to detect a value of acceleration, comprising:
estimating a direction of a speaker utilizing a phase difference of voices input to microphones; and
initializing data associated with estimation of the direction of the speaker, based on the acceleration value detected by the acceleration sensor.

5. A non-transitory computer-readable medium having stored thereon a plurality of executable instructions configured to cause one or more processors to perform operations comprising:
detecting a value of acceleration based on an output of an acceleration sensor;
estimating a direction of a speaker utilizing a phase difference of voices input to microphones; and
initializing data associated with estimation of the direction of the speaker, based on the value of acceleration detected by the acceleration sensor.
